(19) United States
(12) Patent Application Publication
(10) Pub. No.: US 2012/0282061 A1
(43) Pub. Date: Nov. 8, 2012

(54) FASTENER

(76) Inventor: Ming-Chung CHIU, New Taipei City (TW)

(21) Appl. No.: 13/350,380

(22) Filed: Jan. 13, 2012

(30) Foreign Application Priority Data
May 2, 2011 (TW) 100207787

(51) Int. Cl. F16B 21/08

(52) U.S. Cl. 411/348

(57) ABSTRACT

A fastener includes a body member having a head affixed to a plate member and a shank extended from the head, a spring member mounted in a blind hole of the body member, and a rolling member supported on the spring member in the blind hole and partially forced out of the blind hole by the spring member for stopping at a bottom side of a frame member around a mounting through hole to lock the plate member to the frame member.

This application claims the priority benefit of Taiwan patent application number 100207787 file on May 02, 2011.

### BACKGROUND OF THE INVENTION

1. Field of the Invention

The present invention relates to fastening means for joining two plate members together, or fastening a plate member to a frame member, and more particularly, to a fastener, which enables the user's hand to sense the positioning of the fastener in the locking position during installation, enhancing the accuracy of installation and high stability of the mounted structure.

2. Description of the Related Art

Following rapid development of computer technology, it is the tendency in the market to create computers having the characteristics of high power, high speed and small size. To fit an advanced computer for storing a big amount of data, a computer may require one or more extra hard disk drives to expand the storage capacity.

Further, a server case of a server for industrial computer has main board, hard disk drive, fan module, power supply device and many other component parts mounted therein. However, due to limited installation space, component parts must be properly arranged in the server case so that the limited inside space of the server case can be fully utilized. For fully utilizing the inside space of a computer case or server case, the computer case or server case may be divided into multiple compartments for receiving different component parts. When vertically mounting component parts in a limited space area in a computer case or server case, the user may be unable to visually check accuracy of the installation. Under this condition, the accuracy of the installation is determined subject to the user's experience. However, if the component parts are not positively locked, the mounted structure will be instable.

### SUMMARY OF THE INVENTION

The present invention has been accomplished under the circumstances in view. It is therefore an object of the present invention to provide a fastener, which enables the user's hand to sense the positioning of the fastener in the locking position during installation, enhancing the accuracy of installation and high stability of the mounted structure.

To achieve this and other objects of the present invention, a fastener comprises a body member that comprises a head affixed to a plate member, a shank extended from the head and insertable into a mounting through hole of a frame member and a blind hole transversely located on the shank remote from the head, a spring member mounted in the blind hole of the body member, and a rolling member supported on the spring member in the blind hole and partially forced out of the blind hole by the spring member for stopping at the bottom side of the frame member around the mounting through hole to lock the plate member to the frame member. The design of the locking structure of the rolling member and spring member enables the user's hand to sense the positioning of the rolling member in the locking position during insertion of the body member of the fastener into the mounting through hole of the mating frame member.

### BRIEF DESCRIPTION OF THE DRAWINGS

FIG. 1 is an oblique top elevation of a fastener in accordance with a first embodiment of the present invention.

FIG. 2 is an oblique bottom elevation of the fastener in accordance with the first embodiment of the present invention.

FIG. 3 is an exploded view of the fastener in accordance with the first embodiment of the present invention.

FIG. 4 is a schematic sectional side view of the fastener in accordance with the first embodiment of the present invention.

FIG. 5 is a schematic sectional view illustrating an application example of the fastener in accordance with the first embodiment of the present invention (I).

FIG. 6 is a schematic sectional view illustrating an application example of the fastener in accordance with the first embodiment of the present invention (II).

FIG. 7 is a schematic sectional view illustrating an application example of the fastener in accordance with the first embodiment of the present invention (III).

FIG. 8 is an oblique top elevation of a fastener in accordance with a second embodiment of the present invention.

FIG. 9 is an oblique top elevation of a fastener in accordance with a third embodiment of the present invention.

### DETAILED DESCRIPTION OF TEM PREFERRED EMBODIMENT

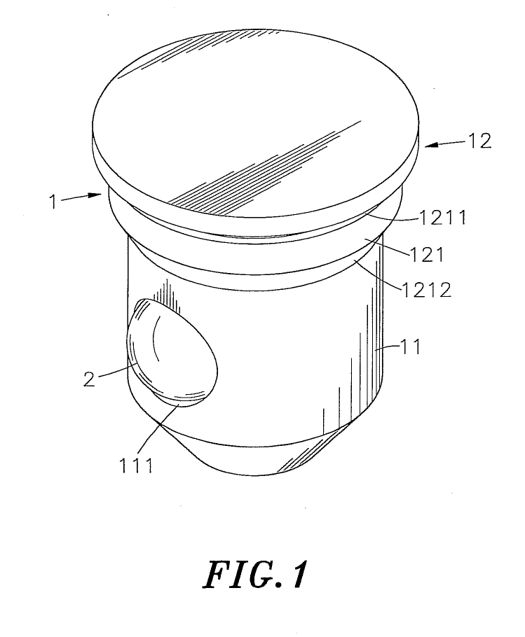

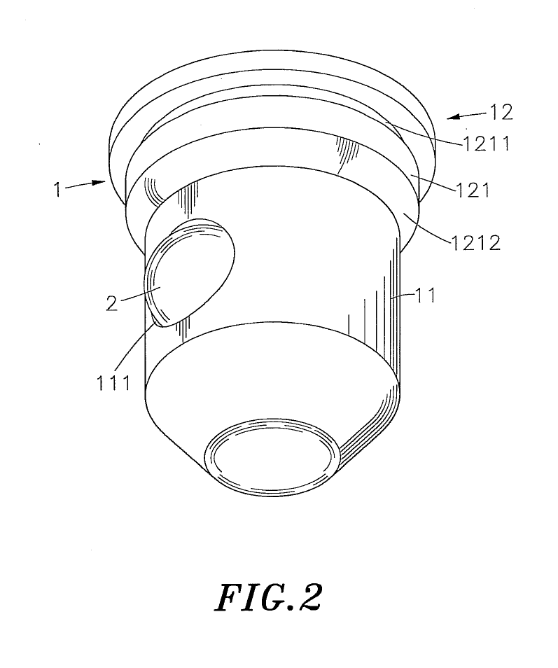

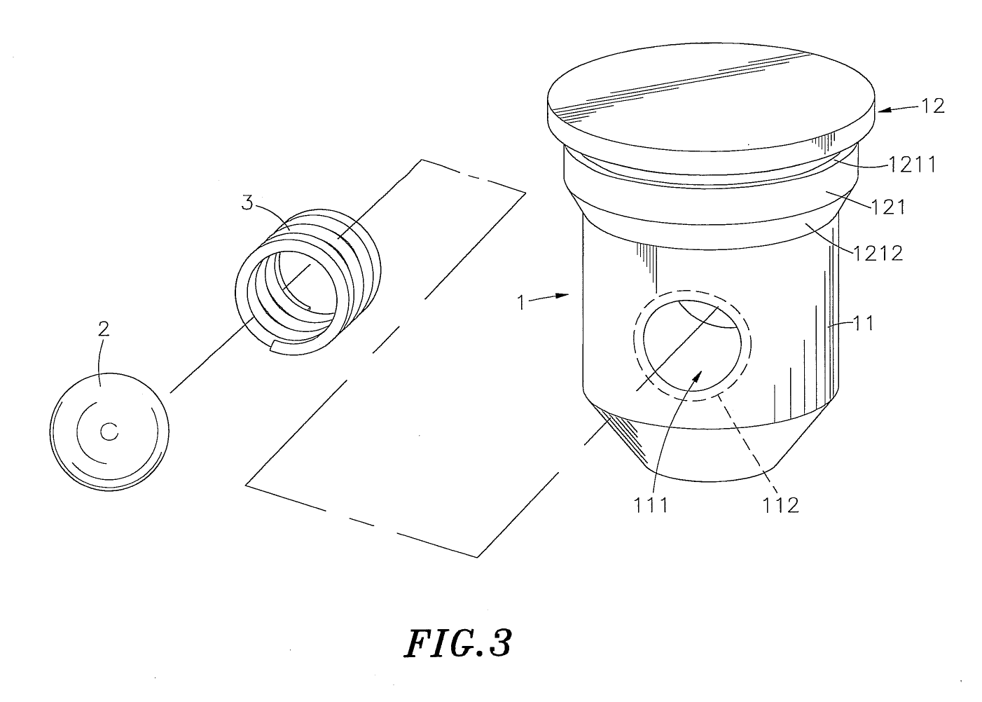

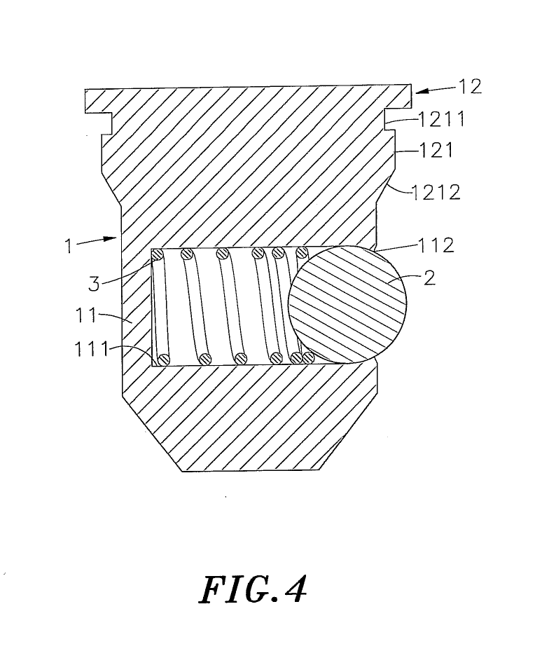

Referring to FIGS. 1, 2, 3 and 4, a fastener in accordance with a first embodiment of the present invention is shown. The fastener comprises a body member 1, a rolling member 2, and a spring member 3.

The body member 1 comprises a shank 11 having opposing top and bottom ends, a blind hole 111 transversely located on the shank 11 near the bottom end of the shank 11, a contracted stop wall portion 112 formed of a part of the shank 11 around the outer end of the blind hole 111, a flat head 12, a shoulder 121 connected between the flat head 12 and the shank 11 and having a diameter smaller than the flat head 12 but greater than the shank 11, a locating groove 1211 extending around the periphery of the shoulder 121 and abutted against the bottom side of the flat head 12, and a tapered surface portion 1212 sloping downwardly inwards from the shoulder 121 toward the shank 11. The spring member 3 is mounted in the blind hole 111. The rolling member 2 is rotatably supported on the spring member in the blind hole 111 and partially forced out of the contracted stop wall portion 112 by the spring member 3.

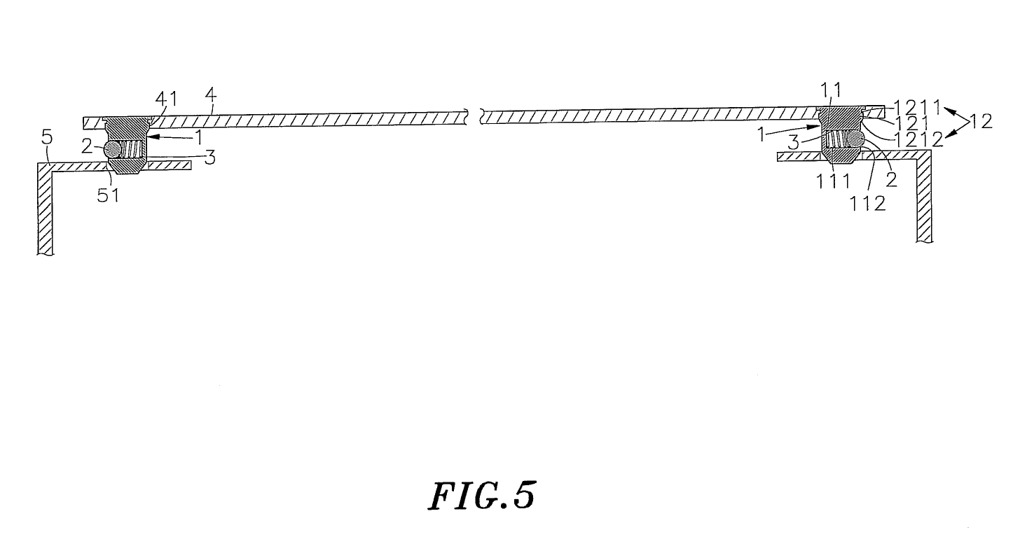

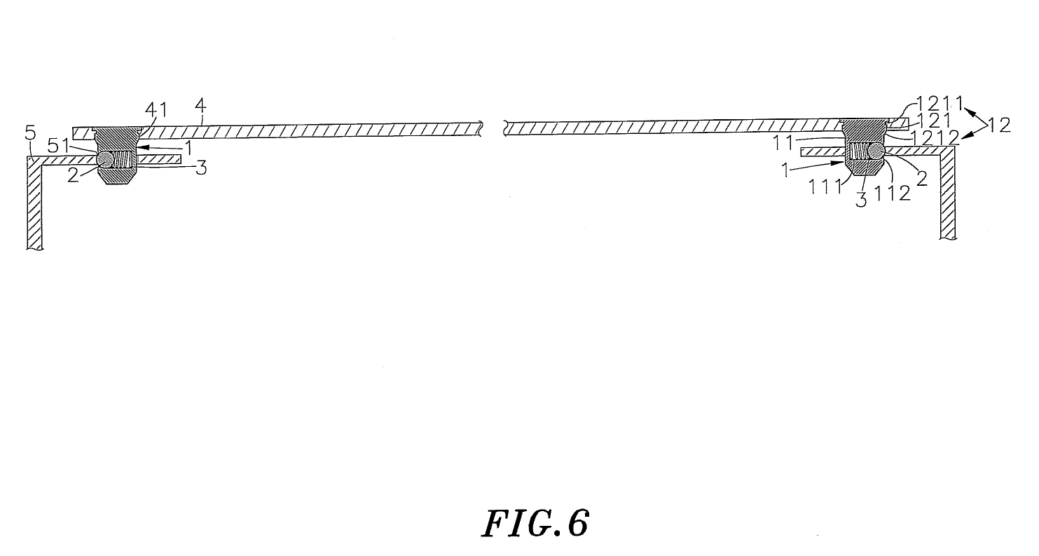

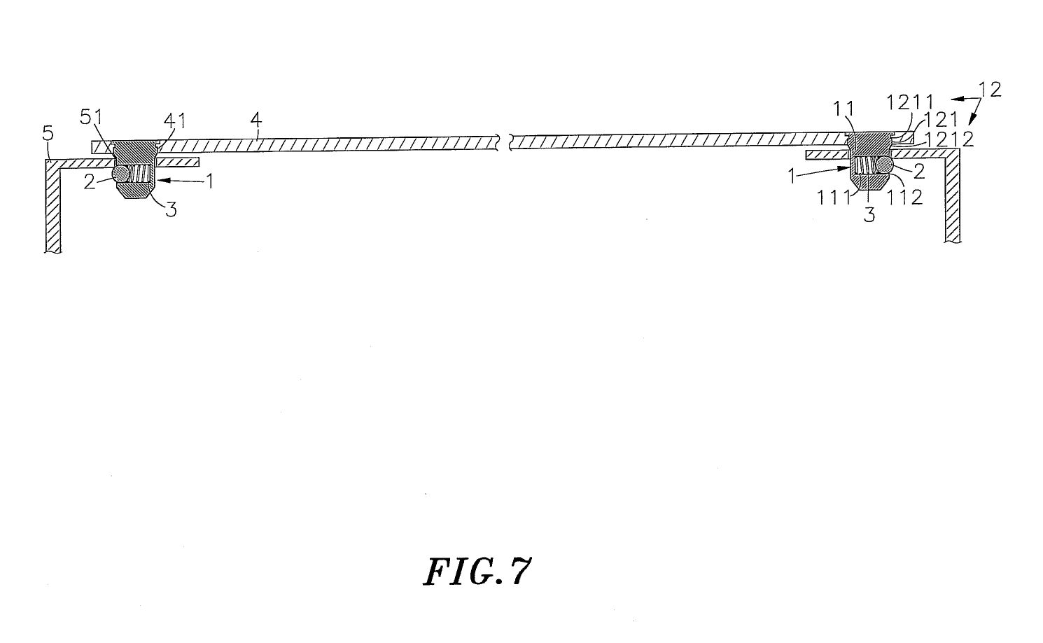

Referring to FIGS. 5, 6 and 7, the upper part of the body member 1 of the fastener above the shank 11 is riveted to a plate member 4. During riveting, the fastener is inserted into a countersunk hole 41 of the plate member 4, and then the fastener with the plate member 4 is put in a riveting die of a riveting machine and riveted, forcing the locating groove 1211 into engagement with a part of the inside wall of the countersunk hole 41 of the plate member 4 tightly. After riveted, the flat head 12 of the body member 1 of the fastener is kept in flush with the top wall of the plate member 4. After riveted a predetermined number of fasteners to the plate member 4, the plate member 4 can be conveniently fastened to a mating frame member 5 by means of forcing the shanks 11 of the fasteners into respective mounting through holes 51 of the mating frame member 5. When inserting the shank 11 of the fastener into one respective mounting through hole 51 of the mating frame member 5, the rolling member 2 of the fastener will be forced backwardly against the spring member 3 by the top edge of the peripheral wall of the mounting through hole 51 for allowing. the shank 11 to pass through the mounting through hole 51. When the rolling member 2 is lowered by the body member 1 relative to the mating frame member 5 below the elevation of the bottom side of the mounting through hole 51, it is immediately forced toward the outside of the blind hole 111 of the body member 1 by the spring member 3 and stopped at the bottom wall of the mating frame member 5 around the mounting through hole 51, and therefore the plate member 4 is locked to the mating frame member 5 by the fasteners. At this time, the tapered surface portion 1212 of the body member 1 is stopped against the top edge of the peripheral wall of the mounting through hole 51. Subject to the design of the tapered surface portion 1212 of the body member 1, the fastener can lock the plate member 4 to the mating frame member 5, leaving a predetermined gap between the bottom wall of the plate member 4 and the top wall of the mating frame member 5. Further, the design of the locking structure of the rolling member 2 and spring member 3 enables the user's hand to sense the positioning of the rolling member 2 in the locking position during insertion the body member 1 of the fastener into the mounting through hole 51 of the mating frame member 5.

Further, the rolling member 2 in this embodiment is a ball. However, this is not a limitation. Alternatively, the rolling member 2 can be made having a cylindrical shape, oval shape, or any of a variety of other shapes that cause less friction and enhance moving stability.

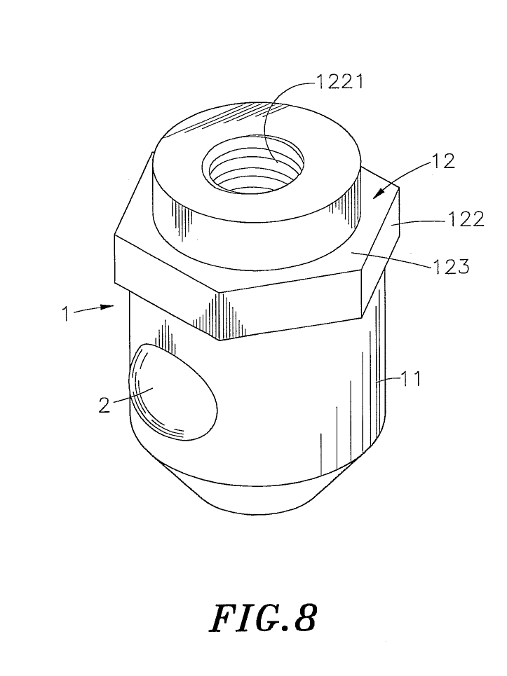

FIG. 8 illustrates a fastener in accordance with a second embodiment of the present invention. This second embodiment is substantially similar to the aforesaid first embodiment with the exception of the design of the body member 1. According to this second embodiment, the body member 1 comprises a shank 11, a head 12, and a shoulder 122 connected between the shank 11 and the head 12. Further, the shoulder 122 in this embodiment is a hexagonal block having a diameter greater than the shank 11 and the head 12. Further, the shoulder 122 defines a stop face 123 at the top side thereof around the head 12. Further, the head 12 defines therein a screw hole 1221. By means of the shoulder 122, the body member 1 can be conveniently rotated with a wrench during installation. By means of the screw hole 1221, the body member 1 can be fastened to a mounting through hole of a plate member with a screw.

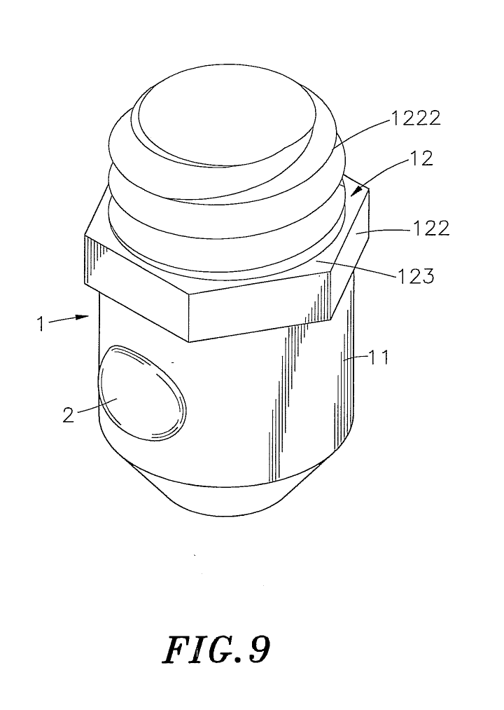

FIG. 9 illustrates a fastener in accordance with a third embodiment of the present invention. This third embodiment is substantially similar to the aforesaid second embodiment with the exception that the head 12 of the body member 1 of this third embodiment has an outer thread 1222 adapted for fastening to a mounting through hole of a plate member with a nut.

Further, it is to be understood that any of a variety of other techniques, such as welding, mortise and tenon joint, chemical bonding, thermal fusion and etc. may be employed to affix the head 12 of the body member 1 to a plate member.

In conclusion, the invention provides a fastener, which comprises a body member 1 that comprises a head 12 affixed to a plate member 4 and a shank 11 for insertion into a mounting through hole 51 of a mating frame member 5, a spring member 3.

mounted in a transversely extending blind hole 111 of the shank 11, and a rolling member 2 supported on the spring member 3 in the blind hole 111 and partially protruding over a contracted stop wall portion 112 at the periphery of the shank 11 around the blind hole 111 for locking the plate member 4 to the mating frame member 5 after insertion of the shank 11 through the mounting through hole 51. The design of the locking structure of the rolling member 2 and spring member 3 of the fastener enables the user's hand to sense the positioning of the rolling member 2 in the locking position during insertion the body member 1 of the fastener into the mounting through hole 51 of the mating frame member 5.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A fastener affixed to a plate member and suited for locking said plate member to a mounting through hole of a frame member, the fastener comprising:
a body member comprising a head affixed to said plate member, a shank extended from said head and insertable into said mounting through hole of said frame member, and a blind hole transversely located on said shank near a bottom end of said shank and remote from said head;
a spring member mounted in said blind hole of said body member; and
a rolling member supported on said spring member in said blind hole and partially forced out of said blind hole by said spring member for stopping at a bottom side of said frame member around said mounting through hole to lock said plate member to said frame member.

2. The fastener as claimed in claim 1, wherein said body member further comprises a contracted stop wall portion formed of a part of said shank around said blind hole to hold said rolling member inside said blind hole and for allowing said rolling member to partially extend out of said blind hole.

3. The fastener as claimed in claim 1, wherein said body member further comprises a shoulder connected between said head and said shank, said shoulder having a diameter smaller than said head and greater than said shank, and a locating groove extending around the periphery of said shoulder and abutted against a bottom side of said head.

4. The fastener as claimed in claim 3, wherein said body member further comprises a tapered surface portion sloping downwardly inwards from said shoulder toward said shank.

5. The fastener as claimed in claim 1, wherein said body member further comprises a shoulder connected between said head and said shank, said shoulder having a diameter greater than said head and said shank and defining a stop face at a top side thereof around said head, and an axial screw hole located on a top side of said head opposite to said shank.

6. The fastener as claimed in claim 1, wherein said body member further comprises a shoulder connected between said head and said shank, said shoulder having a diameter greater than said head and said shank and defining a stop face at a top side thereof around said head, and an outer thread extending around the periphery of said head.

7. The fastener as claimed in claim 1, wherein said rolling member has a spherical shape.

8. The fastener as claimed in claim 1, wherein said rolling member has a cylindrical shape.

9. The fastener as claimed in claim 1, wherein said rolling member has an oval shape.
